(19) United States
(12) Patent Application Publication
(10) Pub. No.: US 2003/0018661 A1
(43) Pub. Date: Jan. 23, 2003

(54) XML smart mapping system and method

(76) Inventor: Parand Tony Darugar, San Diego, CA (US)

Correspondence Address: MARK J. SPOLYAR, 175 PERALTA AVE., SAN FRANCISCO, CA, 94110, US

(21) Appl. No.: 10/198,553

(22) Filed: Jul. 18, 2002

Related U.S. Application Data
(60) Provisional application No. 60/306,538, filed on Jul. 19, 2001.

(51) Int. Cl. G06F 15/00

(52) U.S. Cl. 707/500

(57) ABSTRACT

Methods, apparatuses and systems facilitating mapping of elements from a first XML format to a second XML format using an interface that allows a user to associate elements from the first format to the second format. In some embodiments, a mapping can cause a direct transfer of a value in an input document to an output document. Maps can also be augmented with textual strings and scripts, for example, that can save a value from a first file format to a variable that can be accessed by another script, or save a value in association with a result tag in the second file format. A single tag from the first format can be mapped to multiple tags from the second format, multiple tags from the first format can be mapped to a single tag in the second format, and a single tag in the first format can be mapped multiple times to a single tag in the second format.

### RELATED APPLICATION

The present application claims priority from U.S. Provisional Application Ser. No. 60/306,538 filed Jul. 19, 2001 and entitled “XML Smart Mapping System and Method.”

### FIELD OF THE INVENTION

The present invention relates to structured file formats and standards, such as XML, and, more particularly, to methods, apparatuses and systems facilitating the mapping of a first document or file format to a second document or file format.

### BACKGROUND OF THE INVENTION

Extensible Markup Language, otherwise known as XML, is a term to describe a programming language that allows for the creation of structured file formats facilitating communication and sharing of information. An XML file can be a file, an object that can be delivered by an Object Request Broker, a record in a relational database, or a byte stream. XML allows XML file designers to create customized tags to enable the definition, transmission, validation and interpretation of data between applications and/or organizations. For example, in one application, an XML document can be processed purely as data by a computer program. In another application, the file can be stored as data on a computer. In yet another application, the same XML file can be displayed to a user similar to a Hyper-Text Markup Language (HTML) document.

One advantage of XML is the great amount of flexibility that tags offer; however, this flexibility also results in a general lack of standardization between different XML files. For example, although one industry or organization can theoretically develop XML file formats that can be compatible with other organizations, unless the tags are predetermined or otherwise standardized, compatibility cannot be guaranteed. At present, there is no efficient and easy-to-use mechanism to reconcile incompatibilities between different XML file formats. Because it can be difficult to determine the requirements of a system or application that are necessary to incorporate into a XML file, there can often be significant incompatibility issues that can necessitate a large amount of reprogramming and/or reformatting at a significant time and cost expense.

In light of the foregoing, a need in the art exists for methods, apparatuses and systems that provide an efficient and cost-effective mechanism for reconciling XML files of different formats. The present invention substantially fulfills this need.

### SUMMARY OF THE INVENTION

The present invention provides methods, apparatuses and systems enabling a program or process development environment that facilitates the creation of XML-based applications that map a first file format to a second file format. Additionally, Java code, Perl code, etc., can be written and specified for incorporation into the mapping via the graphical development environment. The present inventions facilitates connectivity, extraction, exchange, manipulation and/or transmission of data between different formats. Furthermore, the present invention allows for customization of components for particular systems or system requirements without requiring the manual generation of XML code.

As described herein, a MAP component and the functionality associated with it facilitate the conversion of an input document having a given XML format to another XML document having a different XML format, without requiring the user to use sophisticated high or low level programming languages to develop code to perform the mapping. Additionally, a MAP component can also convert a data document to a desired XML format without requiring programming. An advantage of the present invention over prior art development environments is, therefore, that the present invention discloses systems and methods providing and supporting a graphical user interface that allows for mapping a source XML file to a result XML file. In one embodiment, a map can cause a direct transfer of a value in the first file format to the second file format. Links or maps can also be augmented with text strings and/or scripts (e.g., Perl, Java, Python, etc.) that can save a value from a first file format to a variable that can be accessed by another script. A single tag from the first file format can be mapped to multiple tags in the second file format, multiple tags from the first file format can be mapped to a single tag in the second file format, and a single tag in the first file format can be mapped multiple times to a single tag in the second format.

In one embodiment, the present invention includes a Graphical User Interface (GUI) that provides the development environment in which the data connectivity, extraction, exchange, manipulation, and transmission operations can be specified and arranged. Through the GUI, projects can be developed wherein a project can be understood as a set of components and the process flow that determines how data moves between components or sets of components. In addition, a project template can be provided for common tasks, such as a purchase order creation template. Templates can also be modified or customized for a particular application.

In one embodiment, a GUI can be presented for access through a network such as the Internet or a Local Area Network. The GUI can allow viewing and selection of database data and Enterprise Resource Planning (ERP) systems using a visual tool. Custom components and composite components can be added to the GUI using HTML and XML. Documented XML format files can be generated automatically, edited, and/or integrated with existing development environments to specify or otherwise define a process flow or a component configuration.

The methods, apparatuses and systems of the present invention can interface to a variety of different databases, such as MySQL, Oracle, Sybase ODBC, Informix, SAP and PeopleSoft, to data transport protocols including SMTP, FTP, HTTP, HTTPS, SOAP, Message Queue Systems —MQ Series, Tibco, and Talarian SmartSockets, and to data transformation formats that include any XML format, HTML, PDF and WML.

### DESCRIPTION OF THE DRAWINGS

FIG. 1 provides a graphical user interface containing a project that includes components in accordance with the present invention.

FIG. 2 sets forth a user interface facilitating the selection of a trigger option from a predefined list of trigger component options.

FIG. 3 provides a user interface facilitating selection and addition of a process component to a project.

FIG. 4 shows a user interface for a MAP component according to one embodiment of the present invention.

FIG. 5 illustrates a user interface graphically showing a mapping of source tags or nodes from a first XML format with result tags or nodes of a second XML format.

FIG. 6 presents a user interface for specifying the parameters and behavior associated with a mapping between a source tag and a result tag.

FIG. 7 shows how the user interface facilitates the mapping of a text string to a result tag.

FIG. 8 illustrates how the user interface facilitates specification of the mapping of text and multiple source tags to a result tag.

FIG. 9 shows how the user interface facilitates the incorporation of computer program code that operates on a source tag value and maps the results of the operation to a result tag.

FIG. 10 is a functional block diagram illustrating the overall process flow associated with the mapping functionality according to one embodiment of the present invention.

FIG. 11 is a flow chart diagram setting forth a method associated with generating mapping code from a mapping XML file.

FIG. 12 is a flow chart diagram providing a method associated with executing the mapping code to map the elements of an input document to an output or result document, according to one embodiment of the present invention.

FIG. 13 is a flow chart diagram showing a method associated with mapping elements of an input document to an output document.

### DESCRIPTION OF PREFERRED EMBODIMENT(S)

To provide an overall understanding of the invention, the following description sets forth certain illustrative embodiments; however, one of ordinary skill in the art will recognize that the embodiments described herein can be adapted and modified other suitable applications and that other additions and modifications can be made without departing from the scope of the present invention.

### I. Overall Project Development Environment

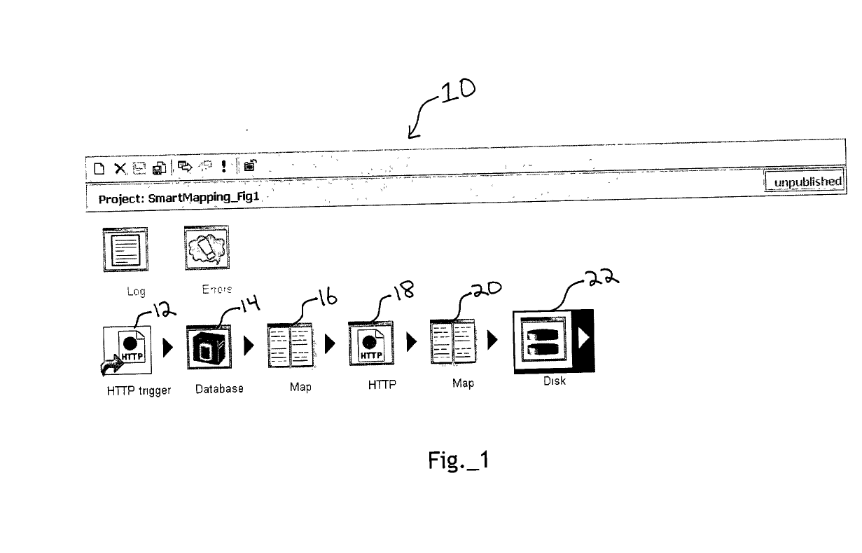

The following describes a graphical project development environment into which the mapping functionality of the present invention can be integrated. Those of ordinary skill in the art will recognize, however, that the mapping functionality described herein may be integrated into other development environments. Referring to FIG. 1, there is shown a user interface 10 including icons for a sample project constructed using the GUI and methods described herein. For the methods and systems described herein, a project can be understood to be a sequence of components that define a data flow, wherein the data flow is initiated by a specified trigger event. As FIG. 1 indicates, a project can include multiple components that are represented as an HTTP request 12, a database 14, a first data mapping 16, an HTTP post 18, a second data mapping 20, and a storage device 22. In one embodiment, data moves between the components in an XML format to allow project standardization. Projects for the illustrated methods and systems can be executed from a specified trigger, and in the project 10 of FIG. 1, the trigger is the HTTP request 12, although those with ordinary skill in the art will recognize that such an example is for illustration and not limitation. In the illustrated project 10, data is extracted from a user via the HTTP request 12 and transferred to database 14 from which additional and/or alternate data is extracted. Using a data mapping technique according to the present invention, embodiments of which are described herein, the extracted data from the database 14 is mapped to a standardized XML format 16 that can correspond to another organization, entity, application, protocol, etc., and posted to a remote server via an HTTP post 18. The remote server can transmit a response that is received and re-mapped 20 to a local XML format before being saved to a disk 22 or other storage device.

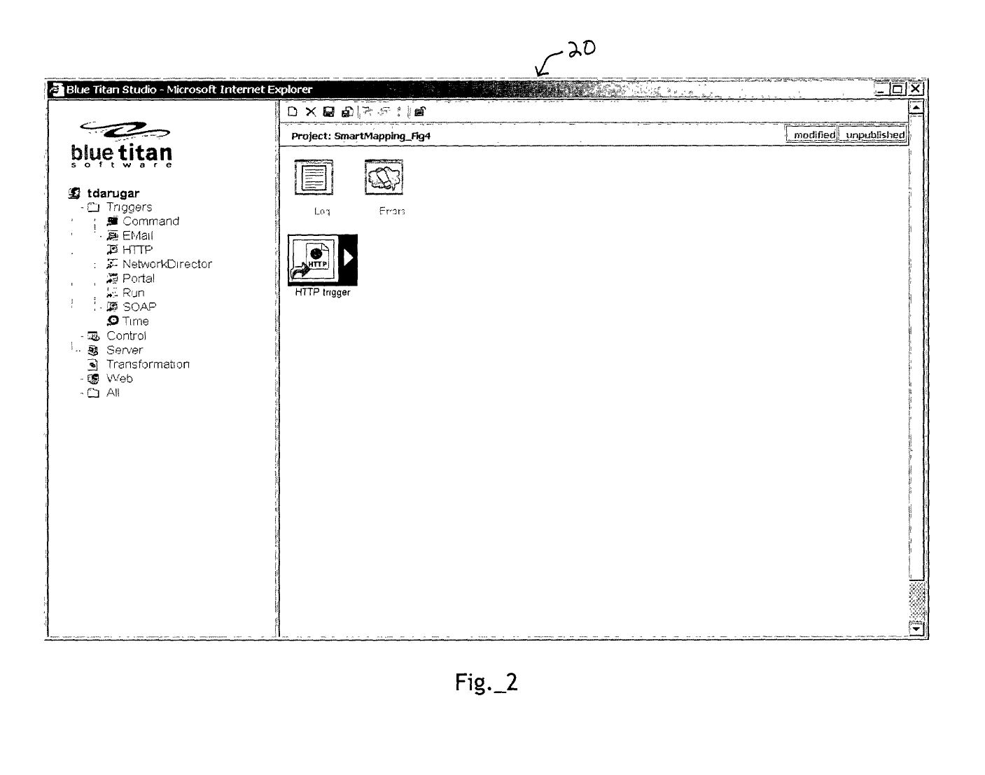

According to embodiments of the present invention, trigger events can be a batch trigger, an email trigger, an HTTP trigger, a Perl Saver Page (PSP) trigger, a Simple Object Access Protocol (SOAP) trigger, or a time trigger. See FIG. 2. Of course, those of ordinary skill in the art will recognize that the present invention is not limited to the trigger options set forth above and that other triggers can be defined and utilized without departing from the scope of the invention. FIG. 2 provides a user interface 20, according to one embodiment of the present invention, wherein a user can select or otherwise specify a trigger by selecting or clicking on a trigger from the menu provided in the left hand column of the user interface 20.

In the illustrated project development environment, batch triggers schedule projects to execute at a specific time and/or on multiple input files that can be read from a storage device such as a disk. An email trigger can define project execution based on incoming email, for example, by parsing the different fields of the email message. As indicated previously, HTTP triggers can cause project execution based upon an incoming HTTP request to an appropriate Uniform Resource Locator (URL). A PSP trigger can define a project for execution by a PSP. Alternately, a SOAP trigger can define a project for publication as a Web Service using SOAP, wherein such projects can have an automatically generated input and output interface defined in a Web Services Description Language (WDSL) file. Time triggers can establish a time schedule for project execution. In the illustrated systems and methods, user interfaces can allow the input of various configuration parameters for the respective triggers, including, for example, time and date of project execution, project identification, input and output schema or format, method names, pattern or regular expression matches (e.g., email trigger), etc.

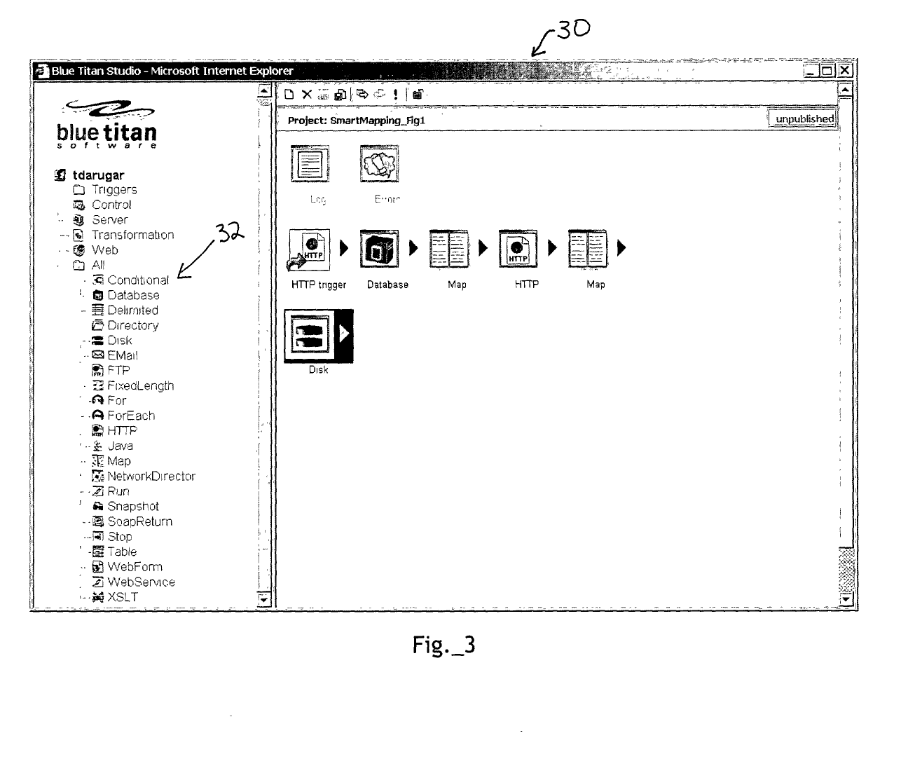

For the illustrated systems and methods, components for a project as shown in FIG. 1 can include a log handler, an error handler, a database, a storage device, an email, an FTP command, an HTTP operation, a javascript, a MAP component, a snapshot component, a webform component a webservice component, or a XSLT component, that shall be described herein. Those skilled in the art, however, will recognize that the invention described herein is not limited for use in development environments supporting only the components set forth above. FIG. 3 provides a user interface 30, according to one embodiment, wherein components can be selected or otherwise specified using menu 32. Similarly, the point of insertion into a project can also be specified using the user interface 30, although the user interface 30 is provided merely for illustration and not limitation. As indicated herein and according to the system of FIG. 1, data flows between components in XML format, and hence, the data input and data output of different components can also be in XML format.

For the illustrated systems and methods, a log handler can record text output that is logged during the execution of a project. Log handlers can be modified to redirect the log handler's output to a specified file name and location. Log handlers can also be configured to specify a log level, wherein for the illustrated embodiments, log levels can include seven different selectable settings between zero and six. For example, a log setting of zero may generate no log output, while a log setting of six may generate or otherwise produce any available debugging information, with settings between zero and six producing increasing amounts of log information, respectively. Those with ordinary skill in the art will recognize, however, that the invention described herein is not limited by the log handler properties, the levels of logging, the relationship of the log levels to the verbosity of the logging, etc., and such information is provided for illustration and not limitation.

For the illustrated systems and methods, error handlers can record errors occurring during the execution of a project. In an embodiment, error handlers can be configured similar to log handlers such that an error log file name and location can be specified, and an error log level between zero and six can be selected.

When considering a database component for the illustrated systems and methods, it can be recognized that the input to the database can be a XML document that defines the data to extract from the database, while the output from the database can also be an XML document that includes the extracted data. The methods and systems described herein can interface to a variety of databases, such as MySQL, Oracle, Sybase, ODBC, Informix, SAP, and PeopleSoft, although such examples are provided merely for illustration and not limitation. The illustrated systems and methods also provide interfaces for specifying a database type, and inserting data into a database (i.e., no output data from this action). An interface can allow a user to enter, for example, a SQL statement with placeholders as a query to a database. When appropriate, database options can also provide a configurable interface to specify a username and password to access a database.

FTP components can be utilized to transfer files from or to a remote server using well-known GET and PUT commands. In one embodiment, a GET operation can accept a XML document as input that includes information specifying the name of the file to open, wherein the output can be a XML document that includes the retrieved file. In an embodiment, the PUT operation can accept a XML document as input to specify the file to be saved, while the output of the PUT operation can be a blank document in one embodiment, or in another embodiment, a XML document that includes a copy of the saved file. In an embodiment, a user interface can allow a user to specify at least one of a file mask that can include a directory path and filename, a file type, a FTP host address, a username, and a password. An input schema and output file type can be selected or specified from a list of XML data types. Optionally and alternately, the input schema can be specified using a “get from previous” option to allow the input file type to be determined by the output of the previous component, while the output file type can be specified by a “get from next” option to allow the output file to be determined by the input of the next component.

Java components can allow integration of a project with Java classes that can be dynamically loaded and executed at runtime. The input to a Java component can be a XML file or plain text that can be used by a Java class during execution. The Java class output can be sent to the next component. In one embodiment, a user interface can allow a user to modify Java component characteristics to specify the Java class, the location of the Java server engine, the input type (e.g., XML, plain text, etc.), the input schema, and the output file type. As indicated for FTP components, Java component inputs/outputs can be specified using “get from previous/next” options.

The HTTP components can get files from, or post files to, a remote server using standard HTTP protocols. For the illustrated systems and methods, the HTTP component input can be a XML file, a URL to access, a type of HTTP request (e.g., GET or POST), a file type (e.g., XML data), and a username and password, if necessary. In an embodiment, a URL can be constructed using information from the previous component output. In an embodiment, a wildcard character, such as “*” can be used to specify utilization of information from a previous component. The HTTP component output can be a response from the remote server, or in a pass-through mode, a copy of the previous component's XML output. Input schemas and output file formats can be selected from specified lists or previous and next components, as described herein.

The disk component can be utilized to read data from, or write data to, a local storage medium that can include a disk, CD-ROM, DVD, RAID system, or any other type of storage device. For a read operation, the input to a disk component can be a XML document that identifies a file to open or data to retrieve, while the output of the disk component can be the opened file or retrieved data. An interface can allow a user to specify a file mask that includes a directory path and filename, and a file type. As with other components, input schema and output file types can be specified using provided XML data types or by reference to previous and next components.

A webform component can capture dynamic content from HTTP-based forms and incorporate the dynamic content into the project. In the illustrated systems and methods, inputs to a webform component can include a URL and XML data that includes the HTML form fields found in the URL. The webform component output can be the result of a HTTP POST or GET provided to the URL. In the illustrated systems and methods, a webform component can typically be found in HTTP-triggered projects. The webform component can generally precede a MAP component. In an embodiment, output from the webform component can be stored in a specified variable or set of variables.

The email component can extract information from an XML document and email the information to one or more recipients. The input to an email component can be a XML document that includes information to be transmitted in a format that can be mapped to an email template, i.e., corresponding to a “to”, “from”, “subject”, “cc”, and “body” fields, although such fields are provided merely for illustration.

The snapshot component can be utilized to save the state of project execution, or recall a previously saved state of project execution for restoration or appending to another component output. The snapshot component output, data values, and XML formatting can be saved or otherwise stored in a specified file in an “as-is” format. Data that is recalled from a previously generated snapshot component data file can be appended to output from the previous component.

The XLST component can transform a XML document using a pre-defined template. The input to a XLST component can be a XML document that includes the data to be transformed. Additionally, the location of the transformation template can be an input to the XLST component. The output is a transformed XML document.

The webservice component can access a local or remote web service using the Simple Object Access Protocol (SOAP). The input to a webservice component can be a XML document having a format defined by service specifications of a Web Services Description Language (WSDL) description file. During project execution, the input to the webservice component can be incorporated into appropriate SOAP headers and transmitted to a specified web service provider. The returned data from the web service provider can be processed and passed to the next project component. A user interface can allow a user to specify the URL of a remote or local WSDL file and associated web service. Inputs and outputs to the webservice component can be fixed according to the remote WSDL specification and may otherwise not be modified in the absence of a trailing or leading MAP component.

As described in more detail below, the MAP component for the illustrated systems and methods can be utilized to map a first XML format to a second XML format. The data mapping functionality described herein allows for data transfer across a variety of system architectures, database configurations, and network protocols, without requiring further XML or other programming. In the illustrated systems and methods, the input to a MAP component can be a structured XML file or raw/plain text data, for example. The output of a MAP component, in one embodiment, is an XML document that includes the input data in an XML format that is compatible with the data flow at the output of the MAP component. As the data is mapped from the input document to the output document via the MAP component, the input data can be transferred directly to the output, or transformed to the output through either textual alteration or a data transformation. Data transformation can occur, for example, by using the input data and an input to a specified computer program or script that can provide an output that is used as an output of the MAP component.

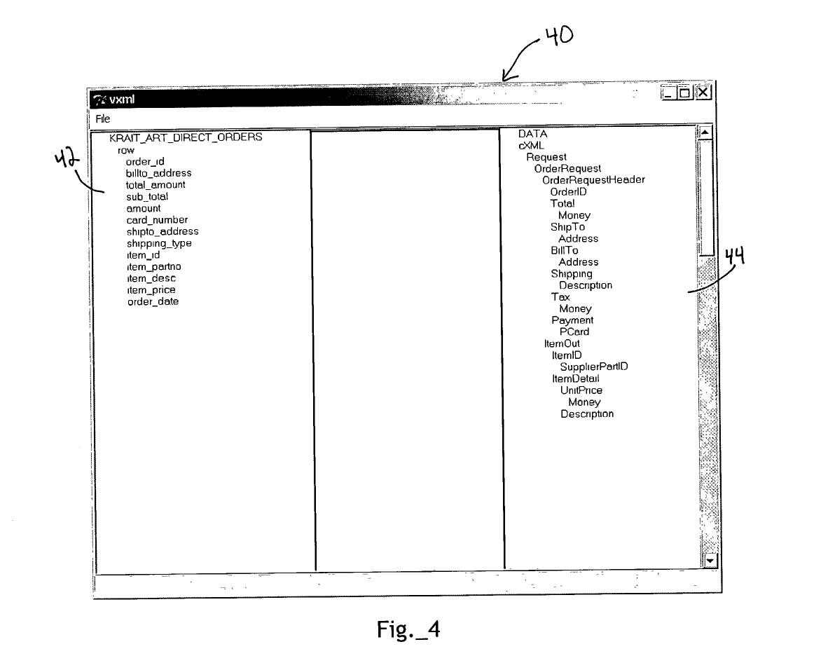

FIG. 4 illustrates a user interface 40, according to one embodiment of the present invention, that allows a user to configure a MAP component operative to map an input XML format to an output or result XML format. The left-hand column of the interface 42 sets forth the tags for a specified MAP component input document, while the right-hand column of the interface 44 shows the tags or elements of a given output document. The input and output of the MAP component can be understood to represent XML formats or documents that include a number of various tags. In one embodiment, a user interface can be provided to allow a user to specify (e.g., browse for and select) files (i.e., XML documents, XML schemas, Document-Type-Definitions (DTDs), etc.) that correspond to the input and output of the MAP component. In one embodiment, a code module is operative to read and extract the file formats from the specified input and output of the MAP component and display the tags or elements as illustrated in FIG. 4.

As to the user interface illustrated in FIG. 4, it can be additionally understood that the input or source document 42 includes source tags nodes, and the output or result document 44 includes result tags or nodes. Accordingly, a source tag or node 42 can be mapped to a result tag or node 44 by designating the source tag, and thereafter designating the result tag to which the source tag can be mapped. In one embodiment, source and/or result tags can be designated, for example, by selecting the respective source/result tags with a computer mouse click. In some embodiments, a single source tag can map to a single result tag. In addition, as discussed in more detail below, a source tag can map to the same result tag multiple times to create an array of associations or multiple result tags or sets of result tags. In one embodiment, data fields can be concatenated into a result node in the order in which the data fields are mapped or otherwise linked.

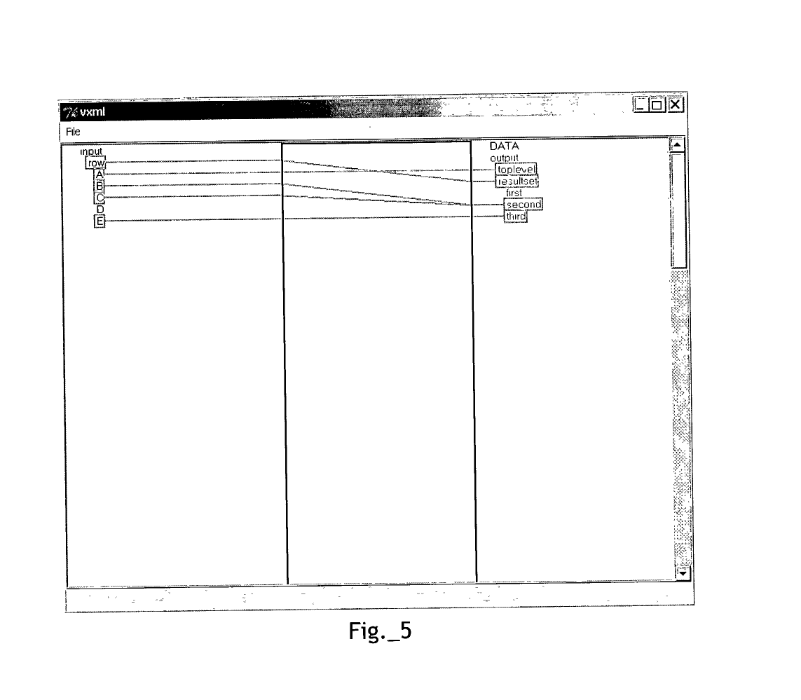

FIG. 5 sets forth a MAP component configuration interface graphically illustrating the mapping of source tags to result tags specified by a user. In one embodiment, for a simple link, the relationship between a source node and a mapped result node can include using a source node to supply a source node value to the mapped result node. In more sophisticated mappings or links, the transfer of values can be modified based on the number of links or maps, for example, or by specifying custom logic or operations executed during mapping between a source node and a result node.

The input and output to a MAP component are, in one embodiment, XML documents. The various elements of the source or input document, otherwise known as tags, can be interpreted or otherwise understood to be search queries for a XML document that is input to the MAP component. Depending on the number of times that a particular source tag or node is found in the source document, different behavior can occur as specified by a user using a MAP component configuration interface. As indicated above, the simplest mapping relationship can be to transfer the source tag value associated with the source tag to the result tag. In other instances, however, text, code or an expression can be added to the mapping function between the source tag and the result tag. Those with ordinary skill in the art will recognize that the examples provided herein discuss mappings of a source and result tag or node, and according to the disclosure herein as previously indicated, mappings can be many to one or one to many, and hence it can be understood that discussion of a single tag can include multiple tags.

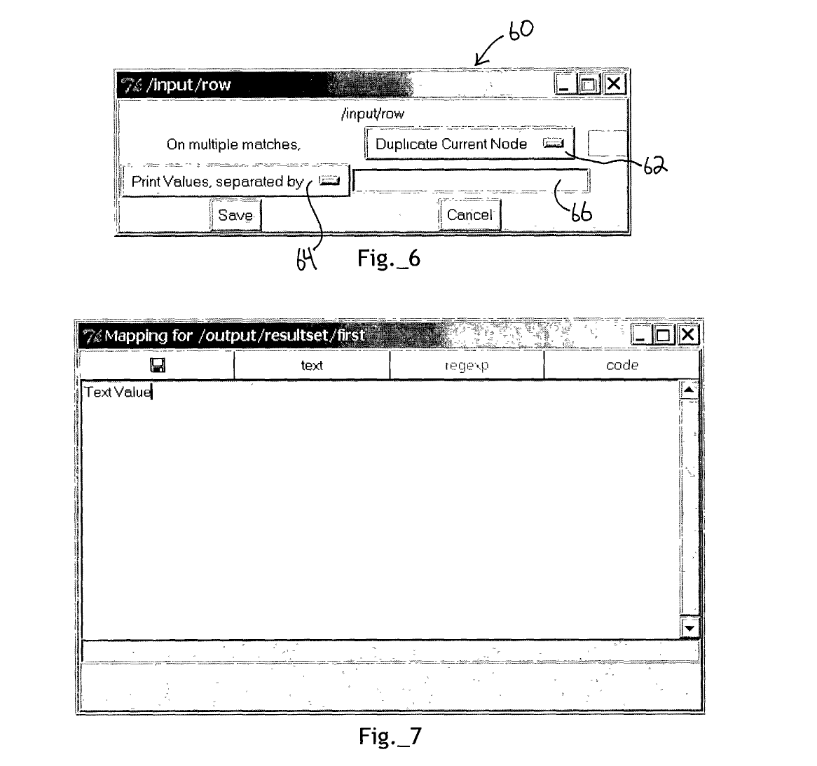

FIG. 6 sets forth a user interface 60 facilitating the configuration of a mapping operation and/or computation when multiple occurrences of a source tag are found in the input document. In one embodiment, a user can select from one from a plurality of predefined operations in response to multiple matching source tags or nodes. For example and in one embodiment, using pull-down menu 62, a user can select a “Match All” configuration, a “Match Only Entry” configuration, or a “Duplicate Node” configuration. When “Match All” is selected, the operation designated in the second pull-down menu 64 is performed on all matches in the result document and stored in association with a single result tag. When “Match Only Entry” is selected, the user interface 60 prompts the user to designate upon which entry (e.g., 1^{st}, 2^{nd}, last, etc.) the operation selected in menu 64 should execute. For example, “Match Only Entry 3” can cause the desired operation to execute only upon the third occurrence of the matching source tag in the input document. Alternatively, selection of the “Duplicate Node” configuration can cause the creation of a new result tag (as well as any children of the result tag) for each occurrence of the source tag in the input document. Of course, one skilled in the art will recognize that a variety of other configurations are possible.

When an occurrence of a source tag in the input document is detected, an operation can be performed and therefore associated with the occurrence. As FIG. 6 illustrates, the interface 60 also provides a pull-down menu 64 allowing a user to select an operation, including “Print, separated by”, that prints the source tag value delimited by the specified separator. Alternatively, pull-down menu 64 allows the user to select a “Save as variable” operation which is operative to save the source tag value as a variable named according to the variable name specified in field 66. The “Save as variable” operation can create a Perl/Java variable/array that includes the source tag value(s) for subsequent accessibility using standard Perl/Java methods.

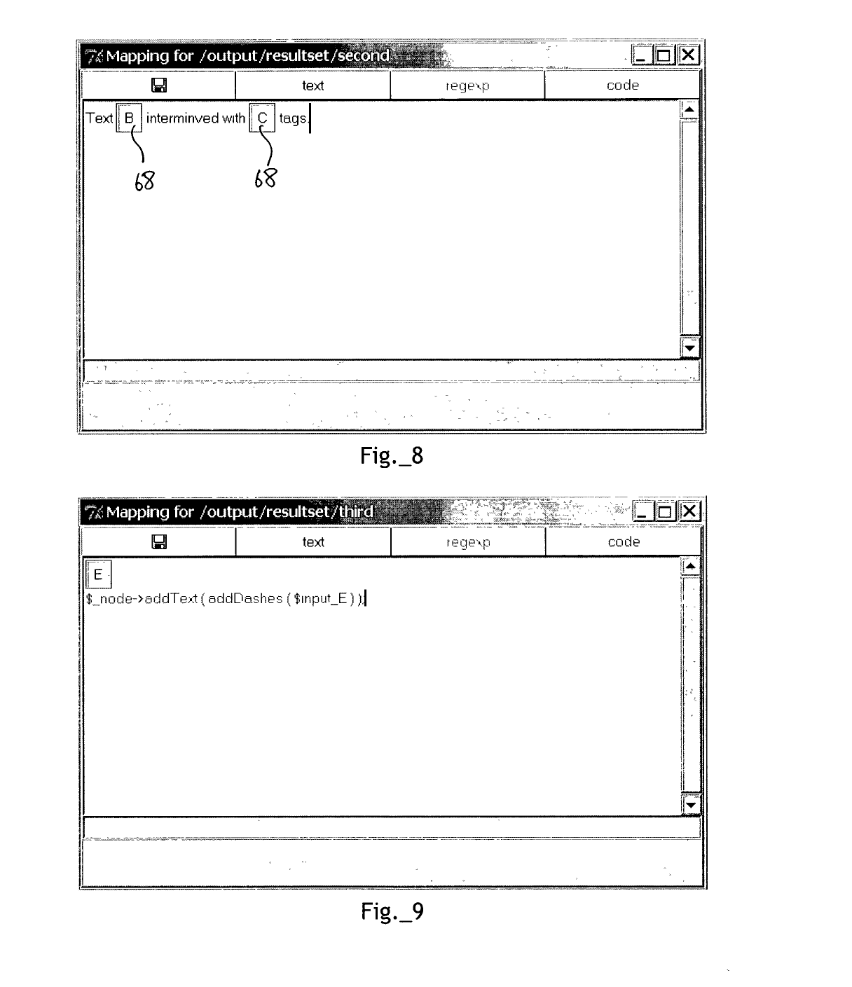

Additionally and optionally, as FIG. 7 illustrates a text value (independent from the input document) can be mapped to a selected result tag. For example, using the interface set forth in FIG. 5, a user may click on the “first” tag of the result document. According to one embodiment, the user interface depicted in FIG. 7 appears and allows the user to configure the mapping. In the example of FIG. 7, the user has specified a text value of “Text Value” that during execution of the mapping function will be mapped to the “first” tag of the result document. In addition, as FIG. 8 shows, icons 68 can be associated with a source tag or multiple source tags, and thereafter an icon associated with a given source tag can be inserted between text specified by the user, wherein the icons representing the source tags can indicate a placeholder for the values of the tags within a text string. FIG. 8 sets forth an interface wherein an output at runtime can be, for example, “An order for 100 widgets was placed, costing a total of $237.63.” As FIG. 8 illustrates, the icons for the various source tags or nodes are based on the tag name from the input document, and the association of a icon with a tag or node can be determined by selecting or clicking the respective icons.

As indicated above, Perl/Java code can be utilized and incorporated into a mapping to enhance or modify the mapping functionality. As discussed above, the “Save as variable” operation can be used to save a source tag value as a variable of a specified name. Accordingly, a user can then create a Perl script or Java code, for example, that uses the variable as an input. In an embodiment, for a mapping, the source tags or document, result tags or document, and current tag (i.e., the tag that is being searched or matched) can be available as Document Object Model (DOM) nodes accessible at runtime during the mapping. Accordingly, the a user can configure a script that operates on such nodes and stores at least one value in a result tag. In one embodiment, the programming language employed matches the programming language (e.g., Perl, Java, Python, etc.) used to construct mapping code.

As with other components, MAP components, in the illustrated embodiments, have an interface to allow a user to specify an input format and an output format. Although XML formats can be selected for both the input and output formats, options of “select from previous/next” can also be selected, and “data” can be an option where data indicates non-XML files, such as HTML files, although HTML files are provided merely as an illustration and not a limitation. In one embodiment, for example, a HTML page can be parsed and incorporated into a XML file format using the MAP component. As to XML files, the input and output formats can be defined by selecting a XML schema, a Document Type Definition, an XML file itself, or any other file that defines the file format (e.g., the tags and the relationship among them). The functionality associated with the MAP component, in one embodiment, is operative to parse these inputs and model the XML format for the input and/or output document.

The illustrated systems and methods, in one embodiment, can also be extended to include a “regular expression” matching capability that, rather than linking a source tag to a result tag, allows for mapping between a regular expression and a result node. In the illustrated embodiments, multiple matches can be effectuated or handled for regular expressions as for XML to XML mappings, including the options to “Match All”, “Match Only Entry”, and “Duplicate Current Node.” Similarly, regular expression matching can be used to transfer data directly to a result node, or to save data to a specified variable for access by program code or script.

### II. Mapping Functionality

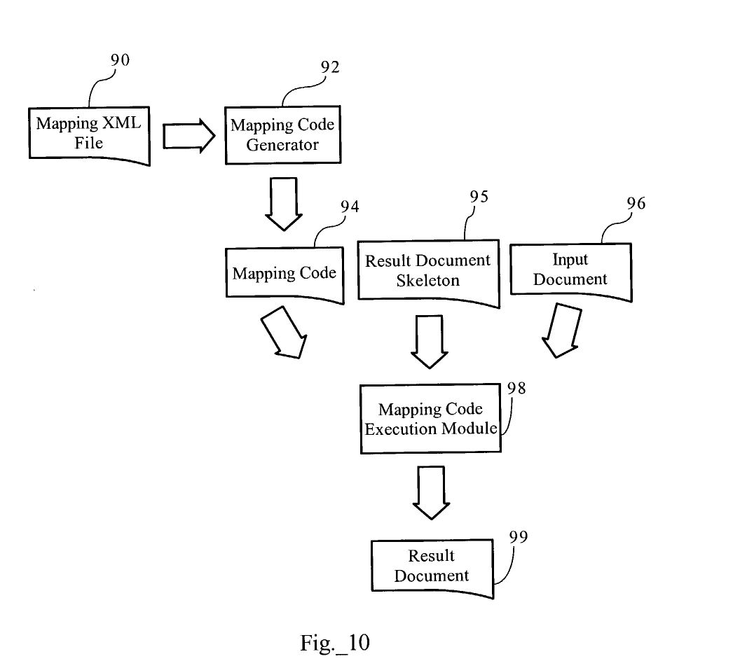

As described above and as the various Figures illustrate, a user specifies a mapping of one XML format to a second XML format using the mapping GUI. In one embodiment, the mapping specified by the user is saved as an XML file (here, mapping XML file) whose attributes characterize the mapping configured by the user. Appendix A sets forth the mapping XML file, according to one embodiment, that results from the mapping configuration illustrated in FIGS. 5,7, 8 and 9. In one embodiment, the runtime execution of the mapping comprises two main components: 1) generation of mapping code from the mapping XML file; and 2) execution of the mapping code for a given input document. FIG. 10 illustrates the overall process flow associated with the mapping functionality according to one embodiment of the present invention. As FIG. 10 illustrates, a mapping code generator 92 uses the mapping XML file 90 to generate mapping code 94 that is operative to implement the mapping of a given input XML document to an output or result XML document. A mapping code execution module 96 is operative to selectively call various mapping functions in the mapping code 94 to implement the mapping of a given input document 98 to an output document 99.

For didactic purposes, Appendix A provides an exemplary mapping XML file according to one embodiment of the present invention. As one skilled in the art will recognize, the tag naming convention as well as the exact hierarchical configuration is capable of a variety of configurations and that the mapping XML file format set forth in Appendix A represents one of myriad possible embodiments. As Appendix A illustrates, the mapping XML file 90, in one embodiment, includes <default> and <display> tags whose values are used to generate the graphical user interface depicted in the various Figures. In the embodiment shown, the <config> nodes define the parameters associated with the MAP component. The <emit> node defines the format of the result document 99, while the <accept> node defines the format of the input document 96. As Appendix A shows, the <mapping> nodes define result document tags for which a mapping function exists, as well as the parameters for each action that makes up these mapping functions.

In one embodiment, the <map> tag corresponds to a mapping action wherein a mapping function comprises at least one action. As discussed above, a user may specify and/or combine several different actions into a given mapping function. Accordingly, to facilitate identification of an appropriate action for purposes of generating mapping code 94, the <map> tag includes several attributes whose values in combination define a particular action. As Appendix A illustrates, in one embodiment, <map> tag attributes include “type”, “mode”, “function”, and “index.” In one embodiment, the type attribute defines an action type; for example, in one embodiment, the present invention includes four action types: 1) xml (mapping an XML source tag to an XML result tag); 2) text (mapping a text string to a result tag); 3) code (adding a script (such as Perl, Python,Java) or other computer program code that operates on one or more nodes in the input document); and 4) regular expression (an action which allows a user to specify a regular expression and an action to be performed in response to one or more occurrences of the expression).

In one embodiment, the mode attribute defines the configuration specified by the user as to multiple matching source tags are treated. For example, a mode attribute value of “select” corresponds to the “Match Only Entry” configuration, the “duplicate” value corresponds to the “Duplicate Node” configuration, and the “matchall” attribute value corresponds to the “Match All” configuration (see above). Similarly, the function attribute defines the operation to be performed in response to a matching source tag in the input document 96. For example, the function attribute value “save val” corresponds to the “Save as variable” operation, while the “print” value corresponds to the “Print, separated by” operation (discussed above). Lastly, the index attribute specifies further details regarding how to match the source tag. For example, in the case where the “Match Only Entry” operation is specified, the value of the index attribute specifies which entry to match (e.g., index =1 indicates the first entry). As Appendix A demonstrates, the type and configuration of tags associated with each mapping element depends on the mapping actions configured by the user.

As discussed above, the mapping code generator 92 is operative to construct mapping code including at least one mapping function. As discussed herein, a mapping function includes at least one mapping action. In one embodiment, mapping code generator 92 includes action code skeletons corresponding to the various actions supported by the system. As discussed herein, mapping code generator 92 combines action code skeletons with the configuration parameters specified by the user to create code implementing the action. These actions are then combined into a mapping function corresponding to a given result tag in the output or result document 99. In one embodiment, the action code skeletons (code templates implementing desired actions) are integrated into the code defining the mapping code generator 92. In another embodiment, the action code skeletons are implemented as a separate skeleton code library. Furthermore, mapping code execution module 98, as discussed above, is operative to select and make calls to the functions in the mapping code in order to map the input document 96 to the result document 99. In one embodiment, a library of mapping helper functions supports mapping code execution module 98. For example, the library of mapping helper functions, in one embodiment, includes function code facilitating the identification of source tag matches in an input document 96, retrieving a value after a matching tag is found. Of course, the library may contain other mapping helper functions.

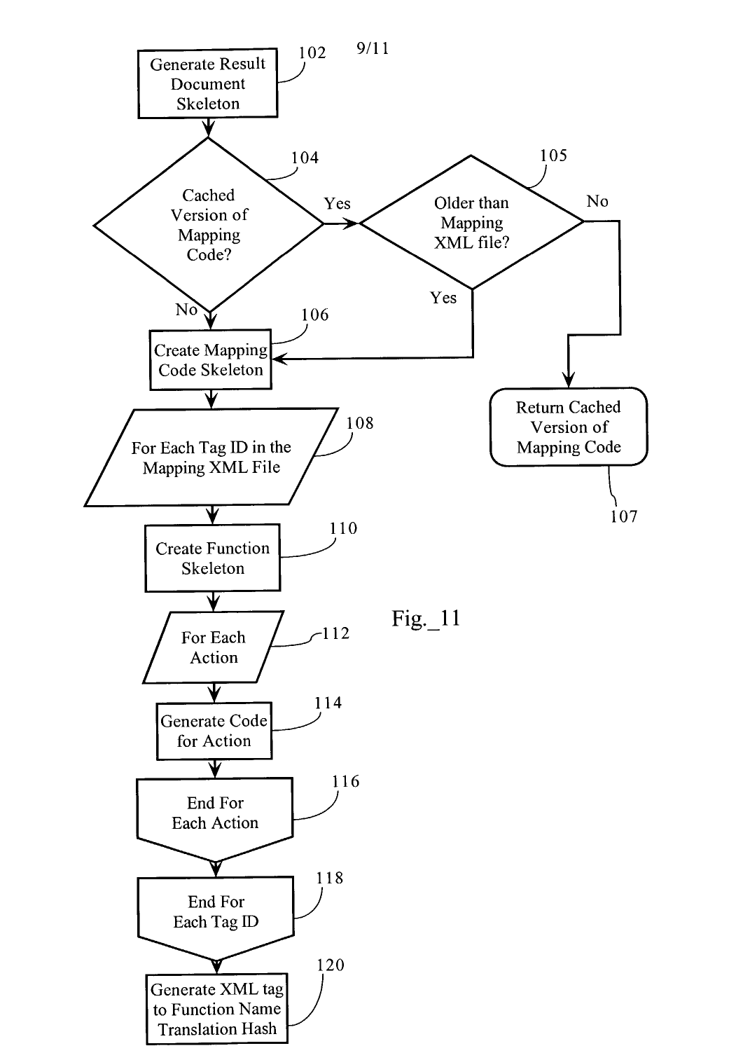

FIG. 11 illustrates a method associated with generating mapping code from a mapping XML file formatted according to the example of Appendix A. In one embodiment, mapping code generator 92 generates a result document skeleton 95, which is essentially a blank output or result document including the tags associated with its corresponding XML format (step 102). In other words, a result document skeleton is a representation of the hierarchical tag configuration associated with the result document format. Mapping code generator 92 then determines whether a previously generated version of the mapping code has already been cached (step 104). If so, mapping code generator 92 then determines whether the cached mapping code is older than the mapping XML file 90 (step 105). If the cached mapping code is not older than the current mapping XML file 90, mapping code generator 92 returns the cached version of the mapping code (step 107). Otherwise, mapping code generator 92 creates a mapping code skeleton (step 106). A mapping code skeleton is essentially a code template into which mapping functions are inserted. In one embodiment, a mapping code skeleton contains header and name space information. Of course, the mapping code skeleton may contain other data or formatting information as required by the particular programming language used to create the mapping code. As FIG. 11 illustrates, for each <tag> in the mapping XML file (see steps 108 and 118), mapping code generator 92 creates a function code skeleton and adds it to the mapping code skeleton (step 110). A function code skeleton, like the mapping code skeleton, is essentially a function template including a function name and function parameters. As the mapping code example of Appendix B illustrates, in one embodiment, mapping code generator 92 creates a function for each <tag> wherein the function names for the resulting functions are essentially ordinals or functionally equivalent to ordinals (e.g., fn0, fn1, fn2, etc.) (see Appendix B). Of course, any suitable function naming convention can be used. For each action (represented by the <map> tag), mapping code generator 92 generates the function code to implement the action configured by the user (step 114). As the mapping code of Appendix A illustrates, in one embodiment, each action or <map> tag includes a plurality of attributes identifying the action as well as values or parameters (e.g., source tag identifiers, text, code, etc.) associated with the action. In one embodiment, mapping code generator 92 is operative to combine these values with action code skeleton associated with the defined action to create the mapping function. Lastly, mapping code generator 92 then generates an XML-tag-to-Function-Name translation hash which allows for subsequent association of a given function name to the result tag for which the function was created. Appendix B sets forth the mapping code resulting from the mapping XML file of Appendix A. The end of Appendix B contains a translation hash, according to one embodiment, that results from the mapping XML file of Appendix A. In other embodiments, the translation hash can be stored in a separate file.

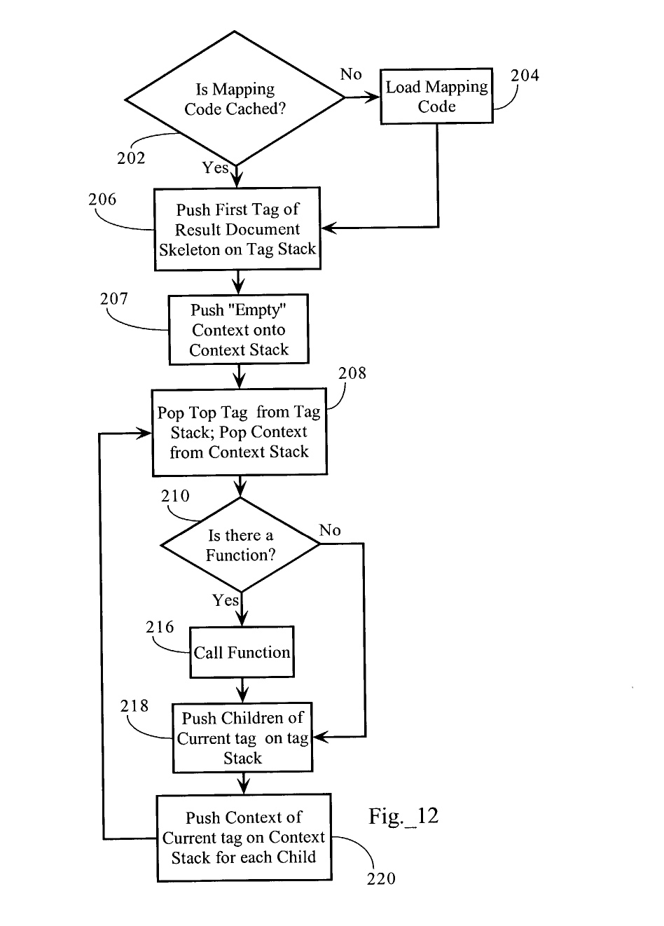

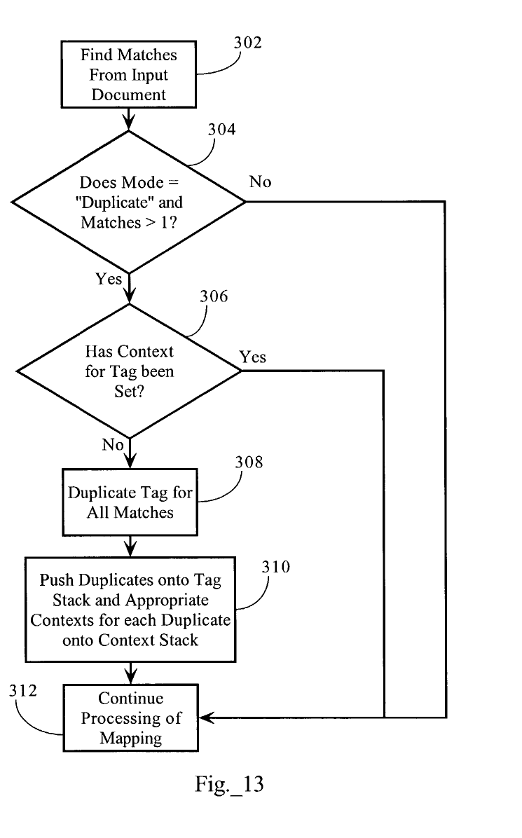

FIGS. 12 and 13 illustrate a method associated with execution of the mapping code to map a given input document 96 to an output document 99. As discussed below, mapping code execution module 98, in one embodiment, uses certain data structures (i.e., a tag stack and a context stack) in connection with the mapping code 94 to execute the mapping of a given input document to an output or result document. Mapping code execution module 98, in one embodiment, first determines whether a cached version of the mapping code exists (step 202). If not, mapping code execution module 98 loads the mapping code 94 into memory (step 204). Mapping code execution module 98 then pushes the first tag of the result document skeleton onto a tag stack (step 206) and an “empty” context value onto a context stack (step 207). Mapping code execution module 98, in one embodiment, operates on the Document Object Model (DOM) representation of the result document skeleton wherein an XML document is represented as a plurality of nodes. One of ordinary skill in the art will recognize how to identify the tags and other nodes in the DOM representation of the result document by following the DOM specification set forth by the W3C standards. In addition, other methods for identifying and processing the input and output documents can be used, such as Simple API for XML (SAX).

Mapping code execution module 98 then pops the top tag from the tag stack and the context from the context stack (step 208). Mapping code execution module 98 then determines whether a function in the mapping code 94 is associated with the tag (step 210). In one embodiment, mapping code execution module 98 makes this determination by scanning the translation hash for a matching tag identifier, if any. If a matching tag identifier exists, mapping code execution module 98 calls the corresponding function in mapping code 94 (step 216). Mapping code execution module 98 then pushes the child tags of the current tag, if any, from the result document skeleton onto the tag stack (step 218) and pushes the context of the current tag on the context stack for each child tag (step 220). As one skilled in the art will recognize, when the current tag is the first or root tag, all child tags of the root tag are pushed onto the tag stack and operated on as described herein. In one embodiment, mapping code execution module 98 pushes the child tags onto the tag stack in reverse order such that the first child tag (as it appears in the result document skeleton) is popped before the subsequent tags. Furthermore, the number of context values that are pushed onto the context stack is equal to the number of child tags; for example, the current tag has five children, five context values are pushed onto context stack. The context stack is used, for example, when multiple matches exists, as well as when “the Duplicate Node” operation has been specified, to keep track of which Match/Duplicate node is currently being processed. A context value, in one embodiment, is a pointer to an element or an identifier for a section of the input document, such as a pointer to the parent tag of a given tag, and allows the mapping code execution module 98 to keep track of where a particular tag fits within the hierarchical format of the result document. The context value can be used, for example, to constrain a search for matching tags to the child tags of a particular tag. In one embodiment, as a tag is popped from the tag stack, its context is similarly popped from the context stack. Otherwise, if no function corresponding to the current tag is found, mapping code execution module 98 pushes the child tag(s) of the current tag onto the tag stack (step 218) and the appropriate context(s) onto the context stack (step 220), as described above. Mapping code execution module 98 repeats the process described above until all tags are traversed.

FIG. 13 sets forth the process flow associated with calling a function in mapping code 94. As discussed below, beyond mapping code execution module 98, a function in mapping code 94 may also manipulate the tag and context stacks. For instance, the “Duplicate Node” configuration setting may result in a mapping code function creating a number of copies of a given result tag and pushing each copy along with its context onto the tag and context stacks. As FIG. 13 illustrates, mapping code execution module 98, in one embodiment, scans the input document 96 to find tags that match the current source tag (step 302). In one embodiment, if the “mode” attribute of the <map> tag equals “duplicate” (indicating the user has configured the MAP component to create duplicate nodes in response to multiple matches, see above) and the number of matches exceeds 1 (step 304), mapping code execution module 98 determines if the node has already been duplicated (or not), by checking whether the context for the current tag has been set or is not a null value (step 306). If no context has been set, mapping code execution module 98 duplicates the result tag for all matches (step 308). Mapping code execution module 98 then pushes the duplicate tags onto the tag stack and the appropriate context for each duplicate onto the context stack (step 310). Mapping code execution module 98 then continues execution of the mapping code function (step 312). For example, as Appendix B illustrates, the mapping code function may map a text value to a result tag, map a value associated with a source tag to a result tag, and/or execute code that processes one or more values from the input document 96 and writes a resulting value in a result tag in the output or result document 99.

Although the present invention has been described relative to specific embodiments, it is not so limited. Many modifications and variations of the embodiments described above will become apparent. For example, although the embodiments described above included mapping functionality that can be augmented with Perl or Java scripts, other scripting languages, such as Python, can be used. In addition, while the embodiments described above generate the mapping code at runtime, other embodiments can generate and store the mapping code for later execution at runtime. Furthermore, other changes in the details, steps and arrangement of various elements may be made by those of ordinary skill in the art without departing from the scope of the present invention. Other embodiments of the present invention will be apparent to one of ordinary skill in the art. It is, therefore, intended that the claims set forth below not be limited to the embodiments described above.

[image]

[image]

[image]

[image]

[image]

What is claimed is:

1. An apparatus enabling a project development environment facilitating the configuration of functionality that maps a first document format to a second document format, comprising
a user interface module, operative to:
receive an input document format and an output document format,
display the input document format and the output document format,
allow a user to configure a mapping between at least one source element of the input document format to at least one result element of the output document format,
a mapping code generator, operative to:
generate mapping code based on the mapping configured by the user,
a mapping code execution module operative to:
selectively execute the mapping code to map an input document formatted according to the input document format to an output document formatted according to the output document format according to the mapping specified by the user.

2. The apparatus of claim 1 wherein the user interface module is operative to store a representation of the mapping in a mapping file.

3. The apparatus of claim 2 wherein the mapping file is an XML file.

4. The apparatus of claim I wherein the mapping code generator includes at least one action code skeleton corresponding to a mapping action; and wherein the mapping code generator is operative to construct the mapping code to include at least one mapping function based on the mapping configured by the user and the at least one action code skeleton.

5. The apparatus of claim 4 wherein the mapping code generator is operative to selectively combine the at least one action code skeleton to the mapping configured by the user to construct the mapping code.

6. The apparatus of claim 1 wherein the mapping configured by the user includes at least one mapping action and mapping parameters associated with at least one mapping action defining a map between at least one source element of the input document format and at least one result element of the output document format, and wherein the mapping code generator is operative to:
load a mapping code skeleton into a memory,
as to a given result element, selectively combine at least one action code skeleton corresponding to the at least one mapping action with the mapping parameters to create a mapping function, and
add the mapping function to the mapping code skeleton.

7. The apparatus of claim 6 wherein the mapping code generator is further operative to generate a translation hash allowing for association of the mapping function to that at least one result element of the output document format.

8. The apparatus of claim 4 wherein the mapping code execution module is operative to selectively execute the at least one mapping code function in the mapping code.

9. The apparatus of claim 7 wherein the mapping code execution module is operative to access the translation hash to identify the mapping code function corresponding to a given result element and execute the identified mapping code function to map the at least one source element to the given result tag.

10. The apparatus of claim 1 wherein the user interface is a graphical user interface.

11. An apparatus enabling a graphical development environment facilitating the configuration of functionality that maps a first document format to a second document format, comprising
a graphical user interface module, operative to:
receive an input XML document format and an output XML document format,
display the input XML document format and the output XML document format,
allow a user to configure a mapping between at least one tag of the input XML document format to at least one tag of the output XML document format,
a memory including a tag stack and a context stack;
a mapping code generator, operative to:
generate mapping code based on the mapping configured by the user, wherein said mapping code including at least one mapping function corresponding to a tag in the output document format; wherein the at least one function is operative to map at least one tag from the input XML document to at least one tag of the output XML document; and
a mapping code execution module operative to:
load a representation of the output document format into the memory,
load a representation of an input document into the memory,
push a tag of the output document format onto the tag stack and a context associated with the tag onto the context stack,
determine whether a mapping function in the mapping code is associated with a tag in the output document format,
locate at least one source tag in the input document corresponding to a result tag in the output document format,
selectively execute a mapping function in the mapping code associated with the result tag to map the at least one source tag of the input document to an output document formatted according to the output document format, and
traverse through all tags in the representation of the output document format.

12. The apparatus of claim 11 wherein the graphical user interface module is operative to store a representation of the mapping in a mapping file.

13. The apparatus of claim 12 wherein the mapping file is an XML file.

14. The apparatus of claim 11 wherein the mapping code generator includes at least one action code skeleton corresponding to a mapping action; and wherein the mapping code generator is operative to construct the mapping code to include at least one mapping function based on the mapping configured by the user and the at least one action code skeleton.

15. The apparatus of claim 11 wherein the context associated with a tag determines which segment of the input document is searched for at least one source tag that corresponds to the result tag.

16. The apparatus of claim 11 wherein the mapping configured by the user includes at least one mapping action and mapping parameters associated with at least one mapping action defining a map between at least one source element of the input document format and at least one result element of the output document format, and wherein the mapping code generator is operative to:
load a mapping code skeleton into the memory,
as to a given result element, selectively combine at least one action code skeleton corresponding to the at least one mapping action with the mapping parameters to create a mapping function, and
add the mapping function to the mapping code skeleton.

17. The apparatus of claim 16 wherein the mapping code generator is further operative to generate a translation hash allowing for association of the mapping function to that at least one result element of the output document format.

18. A method enabling a graphical development environment allowing for the creation of functionality that maps a first document format to a second document format, comprising
receiving an input document format and an output document format;
receiving a mapping configuration between at least one source element of the input document format to at least one result element of the output document format;
generating mapping code based on the mapping configuration;
receiving an input document formatted according to the first document format;
matching at least one source element from the input document corresponding to at least one result element in the output document format;
selectively executing the mapping code based on the matching step to map the at least one source element to the at least one result element in an output document.

19. The method of claim 18 further comprising
storing a representation of the mapping configuration in a mapping file.

20. The method of claim 19 wherein the mapping file is a XML file.

21. The method of claim 18 wherein the mapping code comprises at least one mapping function;
wherein the at least one mapping function is associated with a result element of the output document format, and wherein the selectively executing step comprises selectively executing the at least one mapping function in the mapping code based on the matching step.

22. The method of claim 18 wherein the mapping configuration comprises at least one mapping action and mapping parameters associated with at least one mapping action defining a map between at least one source element of the input document format and at least one result element of the output document format, and wherein the generating step comprises
loading a mapping code skeleton into a memory,
selectively combining action code skeleton corresponding to the at least one mapping action with the mapping parameters to create a mapping function, and
adding the mapping function to the mapping code skeleton.

23. The method of claim 22 wherein the generating step further comprises
generating a translation hash allowing for association of the mapping function to that at least one result element of the output document format.
